(19) United States
(12) Patent Application Publication
(10) Pub. No.: US 2014/0258100 A1
(43) Pub. Date: Sep. 11, 2014

(54) SYSTEMS AND METHODS FOR PROVIDING AN ENGAGEMENT SYSTEM

(71) Applicants: Asim Pasha, Liberty, MO (US); Christopher Robb Heineman, Kansas City, MO (US)

(72) Inventors: Asim Pasha, Liberty, MO (US); Christopher Robb Heineman, Kansas City, MO (US)

(73) Assignee: Sporting Innovations, LLC, Kansas City, MO (US)

(21) Appl. No.: 13/789,372

(22) Filed: Mar. 7, 2013

(51) Int. Cl. G06Q 50/00; G06Q 20/32

(52) U.S. Cl. CPC G06Q 50/01; G06Q 20/322
USPC 705/39

(57) ABSTRACT

Aspects of the present disclosure describe systems and corresponding methods for providing interactive experiences via an engagement system to spectators currently attending or otherwise participating in an event being conducted at a venue. In various aspects, the engagement system may connect the event attendees and/or spectators in an integrated manner by allowing such users to engage in interactive experiences, such as socially connecting to other participants, executing consumer transactions, and/or engaging in various other interactive games, promotions, and/or activities corresponding to the event being conducted at the venue.

### TECHNICAL FIELD

Aspects of the present disclosure relate to social networking, and in particular, to sports social networking platforms.

### BACKGROUND

Historically, sporting events and sports related consumer product consumption has been fragmented by sport, geography, vendors, time etc. For example, if a fan were interested in purchasing sports related products during a sporting event, the fan would have to either wait to the end of the event to purchase desired products, or physically leave the game to purchase any products, causing the fan to miss portions of the product. Additionally, if a fan wanted to interact with another fan during a particular sporting event, typically, the fan would have to physically locate their friend within the sport venue and/or attempt to use conventional communication methods such as making a telephone call is a loud, technically limited sports venue.

It is with these concepts in mind, among others, that various aspects of the present invention were conceived.

### SUMMARY

Aspects of the present disclosure also include methods for providing an integrated event experience. The method includes receiving an access request, at at least one processor, the access request comprising a user identification. The method further includes identifying, at the at least one processor, a user device based on the user identification. The method includes identifying, at the at least one processor, an event at a venue corresponding to a location of the user device. The method includes retrieving, at the at least one processor, venue information based on the user identification and the location of the user device. The method also includes determining, at the at least one processor, one or more social connections based on the user identification, the event, and the venue. The method includes identifying, at the at least one processor, one or more transactions based on the user identification, the event, and the venue. The method further includes generating for display on the user device, one or more graphical user-interfaces for presenting the one or more social connections, transactions, and the venue information.

Aspects of the present disclosure include systems for providing an integrated event experience. The system includes at least one processor to: receive an access request comprising a user identification and identify a user device based on the user identification. The at least one processor is further configured to identify an event at a venue corresponding to a location of the user device and retrieve venue information based on the user identification and the location of the user device. The at least one processor is configured to determine one or more social connections based on the user identification, the event, and the venue and identify one or more transactions based on the user identification, the event, and the venue. The at least one processor is further configured to generate one or more graphical user-interfaces for presenting the one or more social connections, transactions, and the venue information.

Aspects of the present disclosure include systems for providing an integrated event experience. The system includes at least one processor to: receive an access request comprising a user identification and identify a user device based on the user identification. The at least one processor is further configured to identify a sporting event at a venue corresponding to a location of the user device and retrieve venue information based on the user identification and the location of the user device. The at least one processor is configured to determine one or more social connections based on the user identification, the sporting event, and the venue and identify one or more transactions based on the user identification, the sporting event, and the venue. The at least one processor is further configured to generate one or more graphical user-interfaces for presenting the one or more social connections, transactions, and the venue information. The at least one processor is also configured to receive another request for access to the engagement system comprising an admin user identification and generate another graphical user-interface for presenting transactional history information corresponding to the user identification in response to the another request.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1A is a block diagram illustrating a computing environment, according to aspects of the engagement system.

FIG. 1B is a block diagram illustrating dashboard, according to aspects of the engagement system.

FIG. 2 is a block diagram illustrating an engagement system, according to aspects of the present disclosure.

FIG. 3 is a flowchart illustrating an example process for providing interactive experiences, according to aspects of the engagement system.

FIG. 4 is a block diagram illustrating a user interface according to aspects of the engagement system.

FIG. 5 is a block diagram illustrating another user interface according to aspects of the engagement system.

### DETAILED DESCRIPTION

Aspects of the present disclosure describe systems and corresponding methods for providing interactive experiences via an engagement system to spectators currently attending or otherwise participating in an event being conducted at a venue. More particularly, the engagement system connects the event attendees and/or spectators in an integrated manner by allowing such users to engage in interactive experiences, such as socially connecting to other participants, executing consumer transactions, and/or engaging in various other interactive games, promotions, and/or activities corresponding to the event being conducted at the venue.

In one particular embodiment, the engagement system may provide such interactive experiences to attendees and/or spectators (i.e. fans) of a sporting event being conducted at the venue. Accordingly, the engagement system may enable such fans, to interact with other fans, purchase sports related goods and services, and/or participate in sports related games, promotions, and the like. Additionally, the engagement system may allow other users of the engagement system, such as vendors, sports teams, sports leagues, etc., to connect with the fans, provide sports related products and services, provide sports related information, etc., while the event is being conducted at the venue.

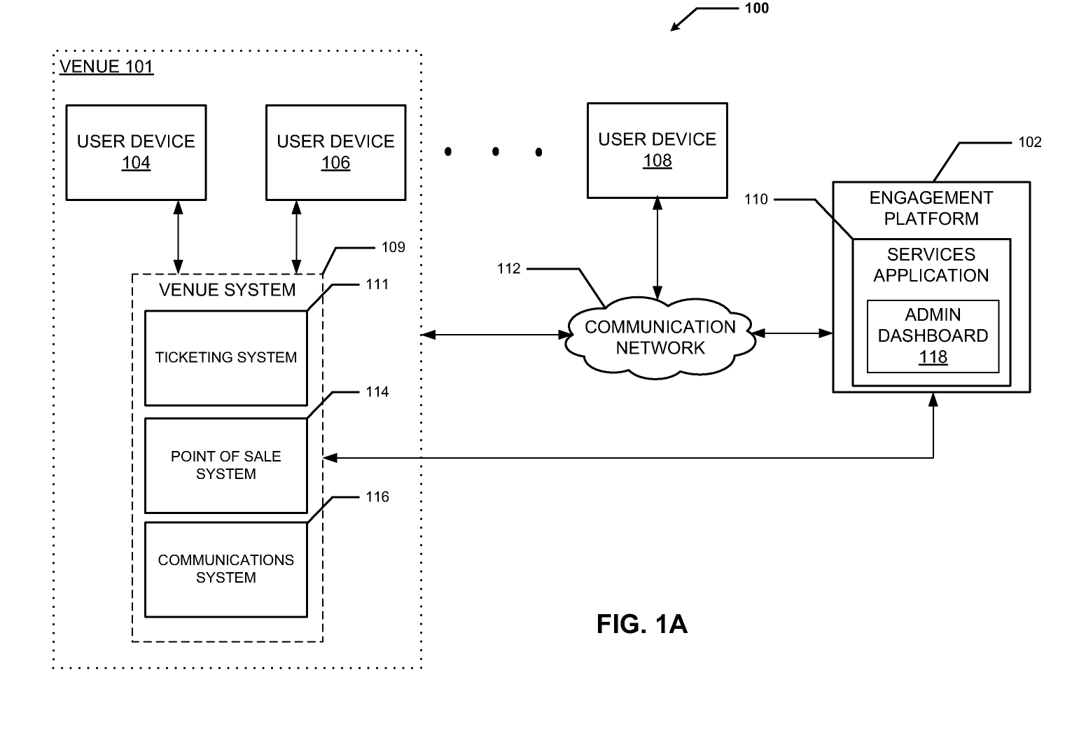

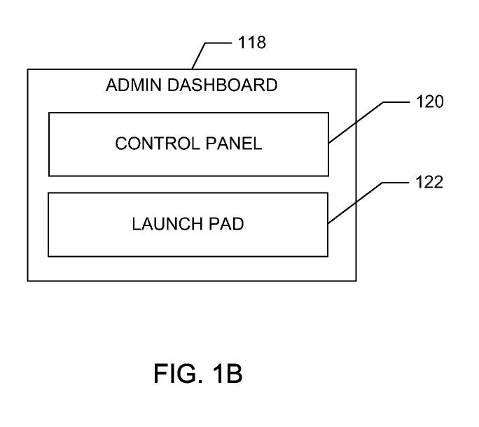

FIG. 1A is an example computing system 100 illustrating the various components of the engagement system according to aspects of the present disclosure. The computing system 100 includes one or more user devices (104-108) that may be accessed by a user that is attending or otherwise associated with an event currently being conducted at a venue 101. For example, in one embodiment, the user may be a fan or spectator (herein referred to as “fan user”) of a sporting event being conducted in the venue 101. Alternatively, the user may be an administrator (herein referred to as “admin user”) associated with the venue 101 and for the sporting event being conducted at the venue 101. The venue 101 may be any type of venue such as a stadium, dome, convention center, conference center, concert hall, and/or other type of venue in which the event may be held.

Each user device (104-108) may be a personal computer, work station, server, mobile device, mobile phone, tablet device, processor, and/or other processing device. Each user device (104-108) may include one or more processors that process software or other machine-readable instructions and may include a memory to store the software or other machine-readable instructions and data. Additionally, each user device (104-108) may also include a communication system to communicate via a wireline and/or wireless communication, such as through the Internet, an intranet, an Ethernet network, a wireline network, a wireless network, a mobile communications network, and/or another communication network and may further include a display (not shown) for viewing data, such as a computer monitor, and an input device (not shown), such as a keyboard or a pointing device (e.g., a mouse, trackball, pen, touch pad, or other device) for entering data and navigating through data, including exams, images, documents, structured data, unstructured data, HTML pages, other web pages, web forms, web application pages, and other data.

The user devices (104-108) communicate with an engagement system 102, which may be integrated with or otherwise executed in conjunction with various components of a venue system 109 to enable the users of the user devices (104-108) to engage in social, gaming, commerce, and/or other interactive experiences corresponding to the event currently being conducted at the venue 101. The venue system 109 may be a computing system including various conventional computing components for venue management, access, communication (e.g. Internet and wireless communication connectivity), operations, entertainment systems, broadcast systems, multimedia systems (video and digital content), and/or various other technological solutions for providing event data and information for large-scale events, such as sporting events to users. For example, as illustrated, the venue system 109 may include a ticketing system 111, a point of sale system 114, and a communications system 116, among others.

The engagement system 102 may be a server that includes one or more processors and memory and may execute various instructions, processes, functions, and/or applications, such as the services application 110, to generate provide various interactive experiences for users. For example, in the context of a sporting event, the services application 110 may be executed by the engagement system 102 to provide interactive sporting event-related experiences by connecting fan users to other fans, vendors, teams, sports leagues and/or other users associated with the venue 101 and/or the sporting event currently being conducted within the venue 101. In particular, the engagement system 102 may generate various user-interfaces, menus, dialogs, and/or other interactive components for display at the user-devices (104-108) that allow the user to experience such interactions. The engagement system 102 may be configured to receive data from, and/or transmit data to, the user devices (104-108) and/or various components of the venue system 109 through a communication network 112. Although the engagement system 102 is depicted as being a single server device, it is contemplated that the engagement system 102 may include multiple servers, and may be integrated and/or otherwise implemented among multiple devices, such as in a cloud computing configuration.

Access to the engagement system 102 may be based on a user profile. The user profile establishes a unique identifier that uniquely identifies each particular user (e.g. fan user or admin user) and provides access to other relevant identification information corresponding to the users, such as: demographical information, name, address, telephone number, social security number, credit card information, and/or other information. In one particular embodiment, the MAC address of the user device (e.g. 104) that the users interacts with to gain access the engagement system 102 may also be obtained and stored with the user profile information for a particular user. Once a user profile has been generated and stored for a particular user, the user profile may be extended to include and/or be associated with transactional records and histories, preferences, social media/social connections corresponding to the user, etc. For example, each transaction record may store the unique identifier of the particular user who participates in or otherwise executes the transaction (i.e. makes a purchase of a good or service). Subsequently, such transaction records and/or histories may be searched based on the unique ID. Accordingly, to retrieve a specific user's transaction history, any transaction records containing the unique identifier corresponding to the specific user may be retrieved.

Once a user profile has been generated for a user, the user may engage in the various interactive experiences enabled by the engagement system 102 during the execution of an event in the venue 101, such as a sporting event. For example, in one embodiment, a fan user may access the user devices (104-108) to interact with the engagement system 102 to access a ticket that the user has purchased corresponding to the event being conducted at the venue. In particular, information corresponding to the ticket may be transmitted to the engagement system 102 from a ticketing system 111 of the venue system 109, which manages and maintains ticket information corresponding to the event being conducted in the venue 101. The ticketing system 111 may include ticket information identifying a ticket corresponding to a fan user that validates the user's admittance to a sporting event is currently being conducted in the venue 101. The ticketing system 111 that interacts with the engagement system 102 may be located within the venue 101, or elsewhere, and may include or otherwise communicate with various ticketing services, such as Stubhub, Ticketmaster, Tickets.com and the like.

A fan user may access the user devices (104-108) to interact with the engagement system 102 to engage in various consumer transactions, such as the purchase of goods and/or services related to the event currently being conducted at the venue. For example, if the event currently being conducted in the venue 101 were a sporting event, users may engage in events such as purchasing: sports related merchandise, in-venue food and beverages, virtual goods, etc. The engagement system 102 may be integrated with or otherwise be communicatively connected to the point of sale system 114 of the venue system 109 that is configured to process payment for any goods and/or services ordered by the user at the venue. In one particular embodiment, the point of sale system 114 may be configured to process payment from the user based on user profile information. For example when a user attempts to purchase a good and/or service while actively logged into the engagement system 102, the user's credit card information included within the user's profile may automatically be retrieved and used to process the transaction. In yet another example, many different types of currencies may be supported by the point of sale system 114 and/or engagement system 102 such as the affinity points, rebates, gift cards, virtual credits, and the like, all of which may be used to conduct virtual transactions in association with the user's profile.

A fan user may access the user devices (104-108) to interact with the engagement system 102 engage in various social networking experiences. The engagement system 102 may include software and/or hardware components implementing various social networking processes. For example, the fan user may interact with the user device 104 to locate other users within the venue that may be engaging in various interactive experiences corresponding to the event being conducted at the venue 101. Such hardware and/or software components of the engagement system 102 may communicate with and/or otherwise access various existing external social networking services, such as Skype, Google+, Twitter, Facebook, etc. Additionally, the engagement system 102 may be integrated with or otherwise communicatively connected to the communications system 116 of the venue system 109 that is configured to provide data, such as audio, video, and/or multimedia data corresponding to the event being conducted at the venue 101. For example, if the event being conducted in the venue 101 were a sporting event, the communications system 116 may stream live broadcasts of the event and such data streams may be accessed by engagement system 102 for integration into an interactive experience.

While one or more fan users are accessing the engagement system 102 and engaging in various interactive experiences, an administrative user, such as a venue administrator, event staff member, and in the context of a sporting event, teams, leagues, players, vendors, etc., may access a dashboard 118 of the engagement system 102 to manage and measure fan user engagement. The dashboard 118 provides a mechanism for such users to visualize, manage, and/or control various aspects of the engagement system 102. FIG. 1B is an example block diagram of the dashboard 118. As illustrated, the dashboard includes a control panel 120, which is an operational tool, module, function, etc., that enables administrative support. For example, the dashboard 118 may allow users to visualize and manage fan user profiles for fan users attempting to access the engagement system 102 and further allow administrative users to generate reporting.

Reports may be generated from any piece of information collected by the engagement system 102. For example, in one embodiment, may provide a comparison of sales trends for an upcoming event against prior trends for similar events. In another embodiment, the reports may include targeted campaign lists that identify potential customers based on the event and user transaction records and/or histories. In yet another embodiment, reports may include a comparison of previously disparate data sets to analyze trends and correlations that most sports teams do not have an easy means for accomplishing.

The dashboard 118 also includes a launch pad 122, which represents a function process, etc., which allows administrative users to visualize and access real-time event metrics corresponding to the event being conducted in the venue 101 and in response, predict relevant content and/or transactional opportunities for users. Examples of real-time metrics include: Number of event attendees, number of current users in and out of a venue, total money spent in venue (with drill-downs into concession types and specific items) and social interactions that have originated from the venue. A user's past purchase history may be used to allow for offers to be presented to the user that will be more likely to be accepted. For example, the engagement system 102 may search for past transactions by the user and leverage that information to create propensity scores for various products that can be purchased during the ongoing event. Such opportunities may then be deployed, considering additional context such as the current location of the user and the timeframe during the event during which the user is most likely to transact (based on past in-event transaction times). While the dashboard 118 is depicted as being included within the services application 110, it is contemplated that the dashboard may be separate from the services application 110 and may be located within the engagement system 102 as illustrated, or elsewhere.

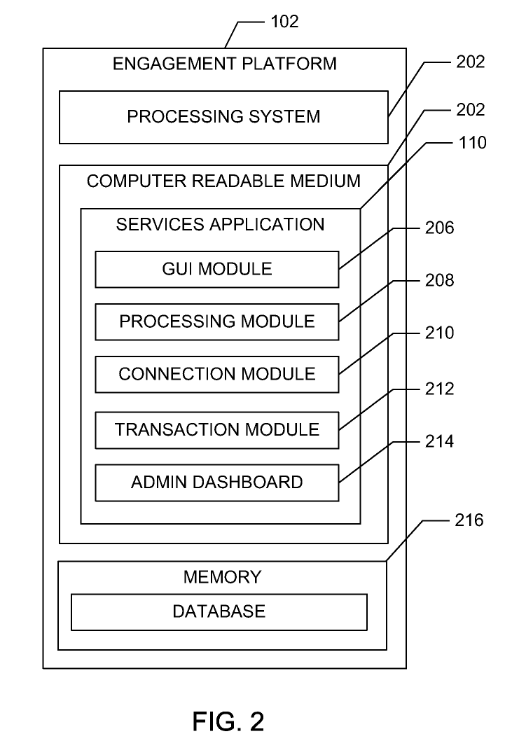

FIG. 2 is an example block diagram illustrating the various hardware and/or software components of the engagement system 102 according to one exemplary embodiment of the present disclosure. As illustrated, the engagement system 102 includes a database 220 that may store one or more user profiles corresponding to the various users interacting with the user devices (104-108) that access the engagement system 102. When a user attempts to access the engagement system 102 at an event, such as a sporting event, the user profile information may be used to uniquely identify the user.

The engagement system 102 may include a processor and/or processing system 202 processing system 120 that includes one or more processors for processing various instructions, functions, threads, processes, and/or application implemented within a computer readable medium (“CRM”) 204 that perform particular tasks or implement particular abstract data types to enable user's to engage in social, gaming, commercial transactions, and/or other interactive experiences corresponding to the sport event currently being conducted at the venue. The processing system 120 may include memory and/or be in communication with a memory 128, which may include volatile and/or non-volatile memory.

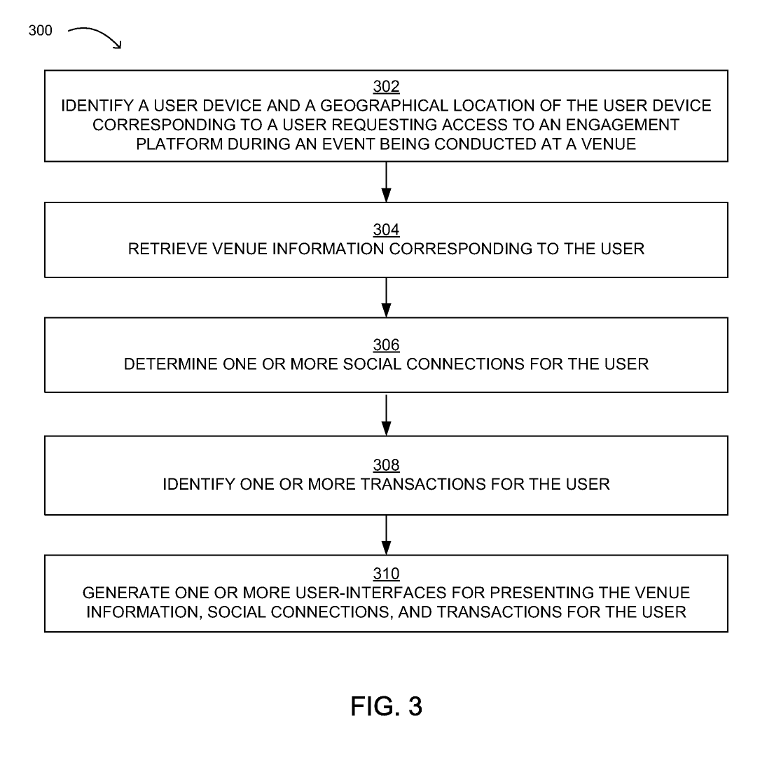

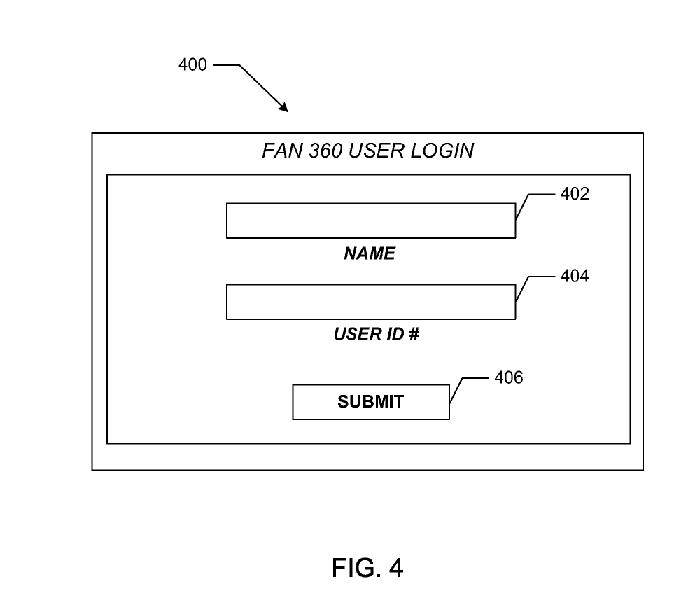

Referring now to FIGS. 1-4, in one particular embodiment, the engagement system 102 may launch, run, execute, interpret, or otherwise perform various logical instructions, such as execution of process 300, which depicts an example method for enabling various interactive experiences of an engagement system. Process 300 begins with identifying a user device and geographical location of the user device corresponding to a user requesting access to an engagement system during an event being conducted at a venue (operation 302). As illustrated in FIG. 2, a GUI module 206 may transmit instructions that may be processed and/or executed to display one or more user interfaces (e.g. web pages, web sites, applications, applets, mobile applications) on the user devices (104-108) for receiving user profile information (i.e. user login and password). Subsequently, a user, such a fan attending a sporting event at the venue 101, may interact with the one or more user interfaces to enter user profile information identifying the user as a valid member of the engagement system 102. FIG. 4 is an illustrative example of an input form 400 for entering user profile data. The user may enter user profile information, such a name 402 and a unique identifier at 404 and press the submit button 406. Other user profile information may also be included.

While receiving the user profile information, a processing module 208 may retrieve MAC address information and coordinate information corresponding to the user device at which the user is attempting to access the engagement system 102. Such information may be used to pinpoint the geographic location of the user device. For example, the processing module 208 may implement or otherwise access an application programming interface provided by the user device operating system to access the MAC address.

Subsequently, the geographical information of the user device, the user profile information, and information identifying the event currently being conducted in the venue 101 may be cached or otherwise stored in the database 220. Such information is cached to prevent additional computing requirements when subsequently analyzing this information. The system may compare current location against previous locations during the same event to create trend maps and allow for triggers such as presenting a consumer transaction or encouraging an alternate route. Location information may be used by user-facing experiences such as map views where a user's location is compared to a desired destination or the location of the user's social connections.

The user profile information may be processed to retrieve venue information corresponding to the user (operation 304). As shown in FIG. 2, a processing module 208 may process the user profile information received by the GUI module 206 to identify venue information corresponding to the user. Venue information includes any information concerning the venue in which the event is currently being conducted, such as maps of the venue, brochures, security information, venue contact information, etc., or any other information describing various aspects of the venue. For example, in one particular embodiment, the processing module 206 may identify a particular seat for the user within the venue 101 and identify navigational information that directs the user to the identified seat within the venue. Additionally, the processing module 206 may identify restrooms, concession stands and/or other physical aspects of the venue 101 that are in close proximity to the user's seat. Other venue information may also be identified.

In one embodiment, the venue information may include information indicating whether a user is actually located within the venue may be obtained. Such venue information can be determined by several different means, including but not limited to: the user scanning a ticket, the user associating to the venue WiFi, the user scanning a QR or other similar code to indicate arrival, the user signing into venue-specific devices such as kiosks, the user being placed at the venue by geo-location technologies within a personal device. Other information that can be obtained could include the seat or seats the user has access to, special clubs or spaces the user has access to, content created while in the venue, exact location as determined by Wi-Fi location-based technology.

One or more social connections may be determined for the user (operation 306). In particular, a connection module 208 may process the user profile information to identify other users that may be logged into the engagement system 102 via a user device that is geographically located within the venue 101 while the event is being conducted. Once a connection has been determined, the connection module 216 may initiate the GUI module 206 generate or more user interfaces that enable the user to communicate and/or engage in various social (i.e. social networking) activities with the user's to which he/she is now connected via the engagement system 102 before, during, and/or after the event being conducted in the venue 101. Additionally, the connection module 216 may determine or otherwise identify users located outside of the venue and/or event, but who have also logged into the engagement system 102. The social networking activities may include: e-mail, instant messaging, SMS messaging, multimedia interactions, text messaging, video and image data sharing, social linking, user profile presentation, and the like. In one particular embodiment, the various social networking activities may correspond to the event currently being conducted within the venue 101. Thus, if the event were a sporting event, the social networking activities engaged by the user may include sending messages including images of the sporting event that were captured by the communications system 116 while the event was executing in the venue 101.

Additionally, various other social activities may be provided such as the ability to view where friends are located (or have been located) in the venue and enable users to encourage other users to meet up. In various embodiments, the connection module 208 may generate transient social networks around each event that tie into specifics of the venue (i.e. venue 101). For example, a social game could contain a leaderboard of all the people within the venue or all people within a certain region or section of the venue to foster new types of competition and/or interaction as described above.

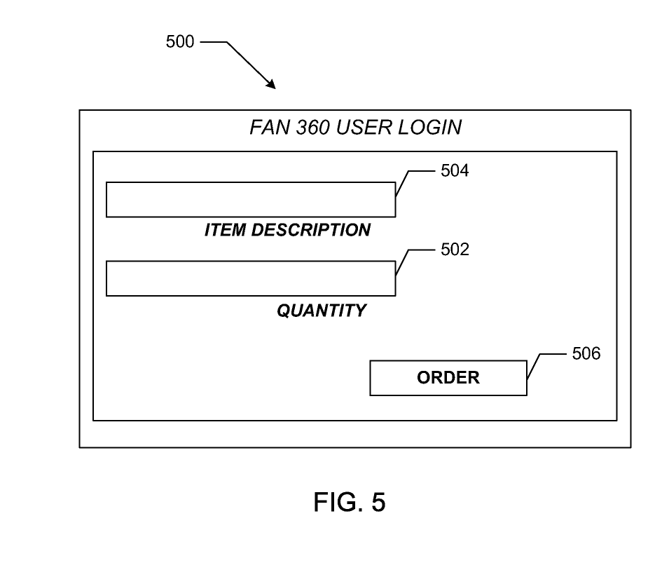

One or more transactions corresponding to the user may be determined (operation 308). More particularly, a transaction module 212 may generate one or more transactions in which the user may engage. More particularly, the transaction module 212 may generate one or more transactions that identify a specific transactional opportunity and the location of such transactional opportunity. Additionally, the transactions may include information describing the propensity of the user to be interested in the opportunity, which may be presented to administrative users, such as via the dashboard, to allow the administrative users to determine which transactional opportunities are most compelling to the user and when such transactional opportunities should be presented. For example, the users may be permitted to purchase goods and/or services related to the event currently being conducted in the venue 101 at a particular time. For example, in the context of a sporting event, the user may be permitted to purchase or otherwise engage in the transaction during a particular period, half, or other temporal delineation associated with the particular sporting event. The various transactions generated by the transaction module 212 may be transmitted for display on the user interfaces generated by the GUI module 206. FIG. 5 is an example user interface including a transaction that may be displayed to a user. As shown, the interface may include one or more components, buttons, and/or forms allowing the user to purchase goods at the venue 101. In particular, a user may choose order two 502 hot dogs 504.

Once any venue information, social connections and/or transactions have been identified or otherwise determined, all of such may be displayed in a user interface (operation 310). Referring to FIG. 2, the GUI module 208 may transmit instructions that may be processed and/or executed to display one or more user interfaces (e.g. web pages, web sites, applications, applets, mobile applications) presenting the venue information, social connections and/or transactions for display on the user devices 104-108.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable and executable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for providing an integrated event experience comprising:
receiving an access request, at at least one processor, the access request comprising a user identification;
identifying, at the at least one processor, a user device based on the user identification;
identifying, at the at least one processor, an event at a venue corresponding to a location of the user device;
retrieving, at the at least one processor, venue information based on the user identification and the location of the user device;
determining, at the at least one processor, one or more social connections based on the user identification, the event, and the venue;
identifying, at the at least one processor, one or more transactions based on the user identification, the event, and the venue; and
generating for display on the user device, one or more graphical user-interfaces for presenting the one or more social connections, transactions, and the venue information.

2. The method of claim 1, wherein the user identification comprises a unique identifier identifying a user and wherein identifying the user device comprises processing the unique identifier to identify a user profile corresponding to the user and obtaining a MAC address and geographical coordinates for the user device.

3. The method of claim 1 wherein the venue information comprises a map of a venue in which the event is located and a location of a seat within the venue on the map for the user.

4. The method of claim 1, wherein each of the one or more transactions is a transaction for purchasing a product from a vendor within the venue in close proximity to the user device.

5. The method of claim 1 further comprising:
receiving another request for access to the engagement system from an admin user; and
displaying transactional history information corresponding to the user identification in response to the another request.

6. The method of claim 1, wherein the event is a sporting event and the venue is a stadium.

7. The method of claim 1, wherein the request is received from the user device.

8. A system for providing an integrated event experience comprising:
at least one processor to:
receive an access request comprising a user identification;
identify a user device based on the user identification;
identify an event at a venue corresponding to a location of the user device;
retrieve venue information based on the user identification and the location of the user device;
determine one or more social connections based on the user identification, the event, and the venue;
identify one or more transactions based on the user identification, the event, and the venue; and
generate one or more graphical user-interfaces for presenting the one or more social connections, transactions, and the venue information.

9. The system of claim 8, wherein the user identification comprises a unique identifier identifying a user and wherein identifying the user device comprises processing the unique identifier to identify a user profile corresponding to the user and obtaining a MAC address and geographical coordinates for the user device.

10. The system of claim 8, wherein the venue information comprises a map of a venue in which the event is located and a location of a seat within the venue on the map for the user.

11. The system of claim 8, wherein each of the one or more transactions is a transaction for purchasing a product from a vendor within the venue in close proximity to the user device.

12. The system of claim 8, wherein the event is a sporting event and the venue is a stadium.

13. The system of claim 8, wherein the at least one processor is further configured to:
receive another request for access to the engagement system from an admin user; and
display transactional history information corresponding to the user identification in response to the another request.

14. The system of claim 8, wherein the request is received from the user device.

15. A system for providing an integrated event experience comprising:
a venue system configured to manage an sporting event being performed at a venue; and
at least one processor in operative communication with the venue system, the at least one processor configured to:
receive an access request comprising a user identification;
identify a user device based on the user identification;
retrieve venue information based on the user identification and the location of the user device;
determine one or more social connections based on the user identification, the sporting event, and the venue;
identify one or more transactions based on the user identification, the sporting event, and the venue;
generate one or more graphical user-interfaces for presenting the one or more social connections, transactions, and the venue information;
receive another request for access to the engagement system comprising an admin user identification; and
generate another graphical user-interface for presenting transactional history information corresponding to the user identification in response to the another request.

16. The system of claim 15, wherein the user identification comprises a unique identifier identifying a user and wherein identifying the user device comprises processing the unique identifier to identify a user profile corresponding to the user and obtaining a MAC address and geographical coordinates for the user device.

17. The system of claim 15 wherein the venue information comprises a map of a venue in which the sporting event is located and a location of a seat within the venue on the map for the user.

18. The system of claim 15, wherein each of the one or more transactions is a transaction for purchasing a product from a vendor within the venue in close proximity to the user device.

19. The system of claim 15, wherein the sporting event is a soccer match and the venue is a stadium.

20. The system of claim 15, wherein the request is received from the user device.
